(19) United States
(12) Patent Application Publication
(10) Pub. No.: US 2008/0289831 A1
(43) Pub. Date: Nov. 27, 2008

(54) Fire extinguishing device

(76) Inventor: Phanawatnan(Woradech) Kaimart, Banglamung (TH)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 11/802,793

(22) Filed: May 25, 2007

(51) Int. Cl. A62C 8/00

(52) U.S. Cl. 169/36

(57) ABSTRACT

An explosive fire extinguishing device is used in interior or localized exterior environments. The force of detonation is minimalized through the use of low-density, low-mass components. A container is composed of a lightweight casing of rigid plastic foam or other suitably frangible material, with an abrasion-resistant, thin plastic, protective, exterior sheathing. Within an internal cavity of the device, the above-mentioned low-yield pyrotechnic detonator is located at or near the center of mass, and is actuated by fuse cords secured at or near the exterior surface. An interior volume of a hollow casing is charged with fire-retardant chemical agents, including dry powders, two-part reactants, liquid components or others, singly or in combination.

### CROSS-REFERENCE TO RELATED APPLICATIONS

U.S. Patent Documents

| | | |
|---|---|---|
| 798623 | September 1905 | Poole et al. |
| 870479 | November 1907 | Stanley |
| 1458972 | June 1923 | Braude |
| 1482522 | February 1924 | Morriss |
| 1565036 | December 1925 | Tank |
| 2306321 | December 1942 | Roberts |
| 2759547 | August 1956 | Zabriskie |
| 2873806 | February 1959 | Bittner |
| 3446287 | May 1969 | Hook |
| 3833063 | September 1974 | Williams |
| 3980139 | September 1976 | Kirk |
| 4964469 | October 1990 | Smith |
| 5232053 | August 1993 | Gillis |
| 5588493 | December 1996 | Spector et al. |
| 5894891 | April 1999 | Rosenstock et al. |
| 5894892 | April 1999 | Huang |
| 6012531 | January 2000 | Ryan |
| 6050343 | April 2000 | Garcia Calvo |
| 6056063 | May 2000 | Hung |
| 6796382 | September 2004 | Kaimart |
| 7028782 | April 2006 | Richardson |
| 7121354 | October 2006 | Munson, Jr. |
| 7147061 | December 2006 | Tsutaoka, et al. |
| 7083000 | August 2006 | Edwards, et al. |
| 7090029 | August 2006 | Cleary, et al. |

### STATEMENT REGARDING FEDERALLY SPONSORED RESEARCH OR DEVELOPMENT

[Not Applicable]

### REFERENCE TO A SEQUENCE LISTING, A TABLE, OR A PROGRAM LISTING COMPACT DISC APPENDIX

[Not Applicable]

### BACKGROUND OF THE INVENTION

The invention relates to fire extinguishing devices. In particular, this invention relates to a device that disperses fire-fighting chemical agents, both wet and dry types, through the use of an explosive force.

The device of U.S. Pat. No. 6,796,382 to Kaimart (same inventor) addressed numerous issues relevant to a low-cost, quickly deployable and highly effective fire extinguishing device. However, from extensive testing and actual use of production versions of that device, it was learned that there remained two areas for improvement, one being a human factor, and the other an improvement in fire fighting efficiency.

In the matter of satisfying human factors and marketing acceptability, aside from ease of use and low cost, it was found that some trepidation existed toward the sound of detonation of the fire extinguishing ball in its original configuration. That highly audible report in common production versions was measured at around 120-125 dB, while thought to be an advantage in literally ‘sounding an alarm’, also frightens many users. It was thus desirable to attenuate the sound of this blast somewhat.

In fire fighting efficiency, testing and actual use again taught that the actual dispersal pattern of fire retardant chemical agents used was not completely and evenly omni-directional. The dispersal pattern was found to be influenced by such factors as external shape of the device, empirically derived modifications to the casing and the shape of the pyrotechnic detonator. Given a cylindrical shape to the detonator, maximum dispersal in terms of the spread of the chemical fire retardant from the epicenter of the detonating blast would be along the axis of such a detonator, while dispersal in a plane horizontal to the axis would be evident, but less pronounced.

Thus, the present invention is a further refinement designed to address these two limitations, while retaining all the attractive qualities of the device of U.S. Pat. No. 6,796,382 granted to the same inventor as the applicant for this device.

### SUMMARY OF THE INVENTION

The object of this invention is to provide an inexpensive, compact and easily used device, which, while being of the explosive type, does not present any serious safety hazard in its actuation.

It is important to establish in this portion of the disclosure that the present invention is a single-use device, which is environmentally friendly in its basic construction, and leaves little more residue than the expended fire extinguishing/suppressant chemicals employed with the device, when actuated. No attempt is made to affect reusability in the device, because a reusable device requires components that can withstand the stresses of a remanufacturing process, add the need for a recycling infrastructure that can not only ‘refill’ the device, but also test and certify that the recycled device can perform again at the required level of protection or usefulness. This of course leads to the requirement that the reusable components must be sturdy enough not only for refilling/remanufacturing, but to be able to reliably perform for more than one use. These preconditions to a reusable device, especially with respect to a device upon which lives and property would depend, it is felt economically prejudices reusable containers or systems for general public use.

What is logically required in a low-cost, easily manufactured, effective fire-fighting device is, a low mass, inexpensively manufactured containment vessel, with a maximum of fire-retardant chemical agent within such a device—viewed as a high relative percentage of weight/mass of the fire-fighting agent to the total weight of the complete functional unit—and a method of dispersal of the chemical agent by a rapid means, which in itself is lightweight, does not create bulk, is inexpensive and places few demands on the device container while the device is stored and unused. General public acceptance also requires other values, as well, those being that it is highly effective in its work, that it is intuitively easy to use, compact enough to be placed anywhere near at hand when needed, and that it be inexpensive.

Thus, the device disclosed herein is intended to have the following features: A simple, self-contained design, and of a construction whose physical integrity and ability to operate can be quickly surmised through visual inspection of its exterior by ordinary persons not highly versed in technical knowledge, and be inexpensive and easily manufactured in nearly any country worldwide; so intuitively simple in its use that even a confused or partially impaired user may employ it with little forethought; so innocuous in size and shape that it may be installed or stored in nearly any environment without esthetic objection; capable of actuation with or without human intervention, and if without, that upon detonation provides sufficient aural report to warn persons in the vicinity of the fire threat. The device of U.S. Pat. No. 6,796,382 did achieve these goals, albeit with the problems described above.

However, to address the aforementioned limitations, improvements were made to the pyrotechnic detonator and the internal surface of the containment vessel. As for the detonator, be it a small black powder charge or other accelerant with sufficient concussive force to disperse the chemical fire retardant material, by infusing and covering the accelerant first within a layer of cotton gauze wadding, wrapping this within a layer of plastic sheet material, and finally wrapping that in an outer layer of polychloroprene synthetic foam rubber (Neoprene) or other soft foam material, such a construction could absorb just enough of the concussive shockwave to attenuate the sound to a more reasonable level. At only a moderate thickness comparable to that of the outer containment vessel of the device, the sound of detonation is thus reduced to about 100-105 dB, safer to human hearing, and audibly much more user friendly while retaining the sound warning merit of the device.

As for the dispersal pattern of the device, the preferred embodiment with a spherical casing is augmented with internal dimpled indentations molded into the casing. Among the desirable patterns for this, these indentations can take the form of hemispherical depressions on the inner surface of the containment vessel, thereby being highly reminiscent of the exterior surface of the common golf ball, only on the inside. These deformations assist in a more even fragmentation of the outer casing upon detonation, more efficiently dispersing the fire retardant chemical filler.

The omni-directionality of dispersal is further enhanced by the shape of the detonator when it is itself spherically shaped, encased in the above components, where the outer layer of polychloroprene, etc. is a pre-formed hollow ball and the accelerant is wrapped with the abovementioned inner layers, and inserted into the ball through a slit (or the ball is made of two hemi-spheres glued together after inserting the accelerant). However, even if the detonator takes the more common cylindrical form, the successive layers of cotton gauze wadding, plastic sheet wrap and then the synthetic foam rubber layer also assist in more even dispersal of the fire retardant chemical filler of the device.

General Description:

The present invention is an explosive, fire-fighting device comprised of three basic components, being—a) A frangible casing whose composition represents no threat as shrapnel, b) Fire-fighting agents such as are commercially available, whether being either dry, wet, or of other form in single or multiple component combinations, c) A detonating device with low explosive yield, insufficient to deliver a debilitating concussive shock to humans at even relatively close proximity to the device during actuation, preferably of a type lacking any constituent part with sufficient hardness, mass or density to constitute shrapnel-like hazard, and be commercially available and commonly found.

In the preferred embodiment, component a) is comprised of a low-density, rigid plastic foam molded to shape, which may be, but is not limited to, a sphere—comprising one hemispherical molded shape, where two of the same molded part form a complete sphere, which again, is not intended to limit the present invention to only one shape, nor exclude other possible configurations of the casing. The internal surface of the containment vessel has molded into it striations, round dimpled indentations or other geometric patterns to help induce even fragmentation of the foam casing and spreading of the fire retardant.

If the seam formed by the assembly of two such hemispheres together may be considered a latitudinal plane of reference, then at the polar regions of the component hemispheres, or other convenient point(s), small holes are located with adjacent exterior surface cavities through which small pyrotechnic fuse cords are protruded and laid flat in the aforementioned cavities. A round filler hole molded into the hemispheres at the joint between them suffices as an orifice for charging the device with the chemical fire-fighting agent(s) after assembly of the casing halves into a whole unit with the detonator already inside.

The wall thickness of a rigid foam casing has been found to be adequate at between 0.8-1.0 centimeter, for a device approximately fifteen centimeters in diameter. An adhesive compatible with the casing material may be employed in assembling the two casing halves, but is not essential.

Surrounding the assembled casing, as outer layers, are typically one or more layers of commonly available, moderate thickness, plastic shrink-wrap film. In the spherical exterior embodiment of this device, the first layer would be a wide band of the shrink-wrap film applied in a vertical orientation, crossing the poles of the sphere, holding secure the two hemispheres, as well as the filler plug, and also covering the fuse ends at the poles. This layer, after low temperature hot air is applied to the shrink-wrap film, covers most of the sphere. A second band, being the same part—in size, thickness and diameter—as the first layer, is applied latitudinally about the seam formed by the two assembled halves. When the second band is heat-contoured to the sphere, the layers together completely cover the exterior of the invention. The shrink-wrap film layer(s), no matter what the external shape of the device is, can provide the structural quality which typical low-density, rigid plastic foam materials for the casing lack, i.e., a tensile external ‘skin’ more resistant to surface abrasion. This sheathing also helps to make the invention highly water-resistant, with the additional modest application of silicone-based, or other, sealants in a few selected areas.

Component b) is the primary, and possibly secondary, fire-extinguishing agent. The choice of chemical agent is limited only to that the core chemical—meaning the chemical charge in a single walled version, or the inner core charge of the multi-walled version of the present invention—should be of the dry powder type, such as of commercially available ammonium phosphates or sodium carbonate types, or any other suitable fire-fighting chemical in dry powder form; otherwise the detonator must be impervious to the agent in any other physical form, or the detonator be isolated from the chemical agent through protective wrapping or coating.

The choice of chemical agent is determinable by availability, cost and intent to specialize a version of the present invention for a particular type of fire hazard.

Liquid or even gaseous agents at or near atmospheric pressure may otherwise be accommodated by adding them to the outer cavity, or cavities, of a multi-walled construction, with outer casing(s) essentially much the same construction as the inner casing, only larger. It has been found that even plain water affords a marked increase in fire-fighting efficacy as an instantaneous coolant, through misting, upon detonation of the device, though other commercially known, specialized liquid agents may provide higher, specialized efficiency.

Component c) is the detonator with fuse cords at either end. Common, commercially available, spherically shaped pyrotechnic detonators are typically of the magnesium/ aluminum powder-based type, and are chosen for wide availability, in sizes with only just enough explosive yield to burst the casing(s) of the device, and disperse the fire-extinguishing agents in an effective pattern.

The detonating explosive charge is wrapped in cotton gauze wadding, or partially infused into it, then wrapped with thin plastic sheet wrap material, and finally encased in a pre-formed, hollow, synthetic foam rubber ball or wrapped in sheets of same, of a thickness comparable to the outer containment vessel of the device, i.e., 0.8-1.0 cm for a 15 cm diameter product. Recycled foam where particles of various densities have been chopped, shredded and re-bonded into mixed strata or pre-formed into spherical hollow balls also tends to work quite well.

A fifteen-centimeter, single component, dry chemical device of this invention has been found to be capable of dispersing its chemical agent up to two meters or more from the point of detonation in a more even omni-directional dispersal pattern—given the preferred spherical exterior configuration—and can effectively achieve spontaneous dousing of flames within that radius for many types of fires, without the need of much explosive force. It has also been found that the force required to disperse dry powder chemical cores in a fifteen-centimeter diameter device of this invention will in most cases cause only slight temporary bruising to bystanders at a stand-off range of 0.5 meters or less, and be very unlikely to cause any permanent injury even if in direct contact; with the device during detonation, depending on variations in actual construction and moderation in choice of detonator yield.

This is due to the fact that the containment vessel, or casing, of the invention is made from the frangible foam material with sheathing as previously disclosed. While this configuration is sturdy enough to sustain the physical integrity of the device against moderate external physical abuse, and permitting a long shelf life, the force required to shatter it from within and disperse its chemical agent(s) is not great.

### BRIEF DESCRIPTION OF THE SEVERAL VIEWS OF THE DRAWING

Included in this disclosure are five drawings of the present invention, including certain modifications to the basic design. These drawings do depict all essential elements of the device; however, they are not intended to limit the external shape to only those shown.

FIG. 1 depicts a cutaway sectional view of the fire-extinguishing device in perspective.

FIG. 2 is a view of the prior art by the same inventor, Woradech Kaimart, in U.S. Pat. No. 6,796,382 (his name has been voluntarily changed to Phanawatnan Kaimart).

FIG. 3 is a view of the basic external shape version of this invention, and locates the plane of reference for the sectional view used in several other drawings.

FIG. 4 depicts a cutaway sectional view of the fire-extinguishing device of the outer casing (containment vessel) showing only the inner surface of the casing in perspective.

FIG. 5 is a sectional view of a double-walled modification to the basic design of the fire-extinguishing device.

FIG. 6 is an exploded, perspective view locating details at the rear and base of the present invention.

FIG. 7 is a cutaway sectional view of the improved detonator in a spherical shape using a preformed outer synthetic foam rubber hollow ball casing.

FIG. 8 is a cutaway sectional view of a more common cylindrical detonator using sheet wrap layers.

### LIST OF REFERENCE NUMERALS EMPLOYED IN THE DRAWINGS

1.—Region of overlap between shrink-wrap plastic film layers

2.—Vertically (or ‘longitudinally’) bound shrink-wrap plastic film layer

3.—Frangible casing

4.—Tongue-and-groove joint cast into the rim of the hemispheres

5.—Detonator, encased in sponge foam rubber, etc.

6.—Fuse cord (at either end of detonator)

7.—Horizontally (or ‘latitudinally’) bound shrink-wrap plastic film layer

8.—Fire-extinguishing chemical agent filler

9.—Filler hole and fitted plug

10.—Seam between hemispherical casing halves

11.—Secondary fire-extinguishing chemical filler within outer cavity of double-walled modification of the basic design

12.—Spacer ring between inner and outer casings

13.—Molded-in polar locating nodes, double-walled modification

14.—Outer casing, double-walled modification

15.—Binding (string) for detonator ends, if not a preformed casing

16.—External surface of detonator casing

17.—Pyrotechnic filler

18.—Layer of cotton gauze wadding

19.—Edge of vertical shrink-wrap band enclosing containment vessel

20.—Plastic wrap layer (can be the same shrink-wrap material used elsewhere, but heat is not applied)

21.—Dimpled indentations on the inner surface of the containment vessel.

22.—Edge of horizontal shrink-wrap band enclosing containment vessel

### DETAILED DESCRIPTION OF THE INVENTION

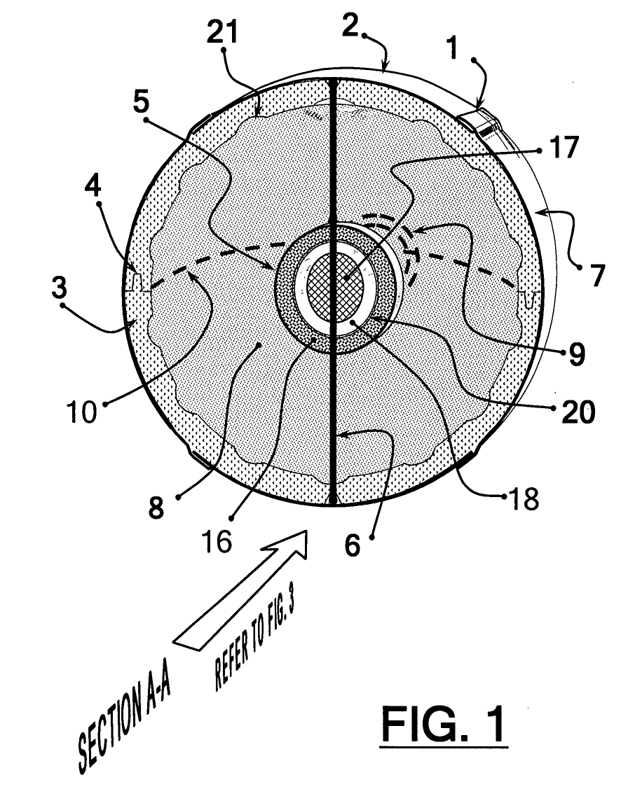

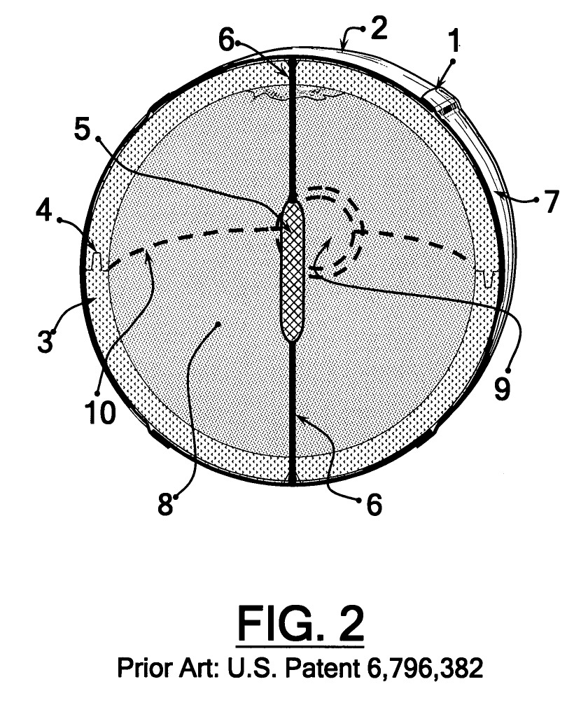

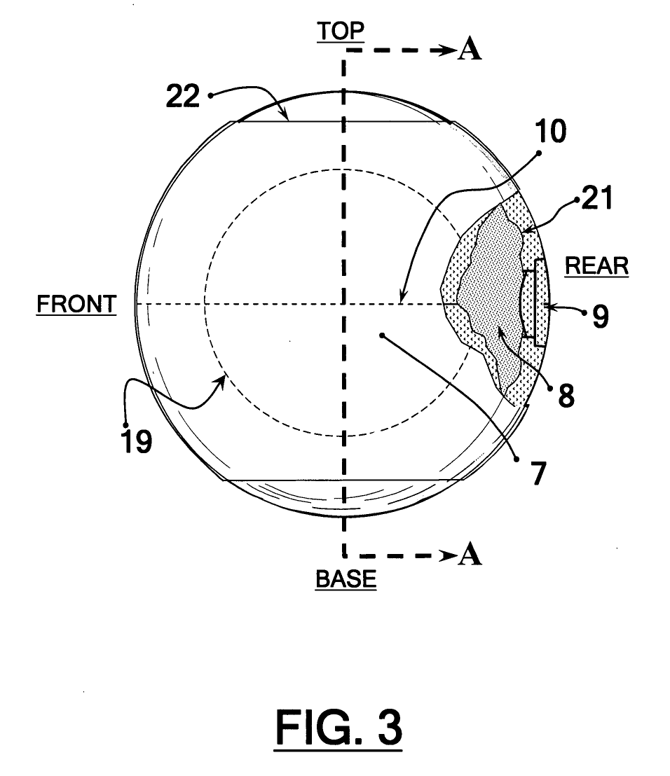

To meet the prescribed specification in the Summary, the containment vessel, seen in FIG. 1 and other drawings as 3, of the present invention utilizes lightweight, low density, rigid plastic foam as the preferred material, and specify among the current best choices, EPS (expanded polystyrene foam). Environmentally friendly, this material is molded into the required component shape, of which the preferred embodiment would require a hemisphere, because the sphere assembled from it is basic and efficient in terms of manufacture, the ratio of interior volume relative to surface area is highest, and thus the size of the device is minimized, as well as being that shape which results in the most evenly omni-directional dispersal pattern when utilized.

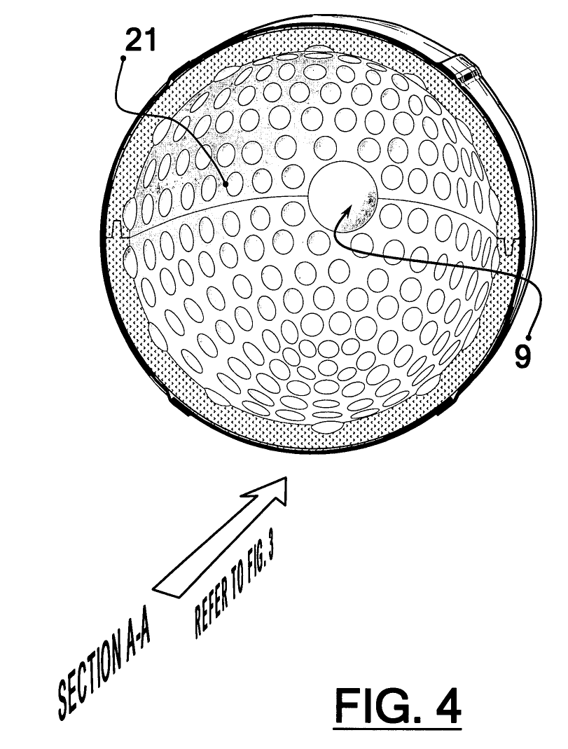

In a spherical exterior embodiment, half of the rim of each hemisphere could feature a tongue protrusion and matching groove 4 on the other half of the rim—or other joint features, excepting a small portion of the rim reserved for (half of) the filler hole and fitted plug 9, permitting a single molding to be used for both sides of the sphere with a secure joint between them 10. The interior surface of these hemispheres are dimpled with numerous indentations as seen in FIG. 4, striated with linear grooves vertically and horizontally, or similarly deformed with other geometric patterns to aid in even fragmentation upon detonation of the device.

The present invention is intended to be projected by hand—meaning tossed, rolled, dropped, mechanically propelled or otherwise delivered directly into the vicinity of a fire, upon which fuse cords 6 at either or both polar ends of the sphere would be ignited, subsequently activating the pyrotechnic detonator 5, whose explosive yield would shatter the foam casing and disperse the chemical agent(s) 8. This preferred embodiment is amongst the most economical solutions possible for the actuation of the device. This disclosure does not contend that the common paper or cardboard-wrapped fireworks pyrotechnic detonator is the only type which may be used, however, It is intended that, for general public use, the detonator chosen must be of a type constructed of materials with such low density and mass of constituent parts that they effectively disintegrate into minute, non-hazardous flying debris upon explosion of the detonator.

Assembly of the present invention from its component parts begins with threading one of the fuse cords 6 of the detonator 5 through the hole made for it in the plastic foam casing 3, and then cutting that cord off at such a length and inserting its end into a casing depression cavity for the fuse 6 tip such that the detonator 5 will be suspended in the approximate center of mass of the assembled device. The other fuse cord at the other end of the detonator is then likewise threaded through a hole in the base of the casing, and the two casing halves are pressed together and held in place by a tongue-and-groove joint 4, or other joint feature, whereafter the second fuse cord is likewise cut to length and embedded into a pre-molded depression cavity on the casing's surface.

A dry chemical fire-extinguishing/fire-suppressant agent 8 is then poured through the filler hole 9 into the casing until it is full, and the hole is then closed with a molded-to-fit plug. A pre-sized plastic shrink-wrap band 2 or 7—typically of PVC plastic, due to its lower heat requirement for shrinkage than polyolefin film—is then fitted to the casing 3 or 14. In the spherical embodiment, one shrink-wrap film band 2 would be fitted vertically (meaning that the centerline of the band would be oriented longitudinally), wherein the centerline of the circular shrink-wrap band should cross and cover the fuse cord 6 tips lying in cavities at the top and base of the assembly, as well as crossing the centerline of the filler plug 9 at the seam between the hemispheres 10, in this preferred configuration.

That single shrink-wrap band 2 would effectively constrain the entire assembly of a sphere into a bound and sealed unit, but would not ordinarily cover the sphere's entire surface, due to the maximum shrink ratio of typical plastic shrink-wrap film being usually insufficient for the edges of the shrink-wrap band to effectively reduce their contour under application of hot air to completely, and neatly, enclose the entire spherical surface. Thus, lacking a film with higher shrink ratio characteristics, the width of the shrink-wrap band is limited to that width which can be neatly contoured onto a spherical shape.

A second band 7 is then necessitated to the spherical assembly, this one latitudinally applied, i.e., fitted with the centerline of this band being co-located in a plane with the seam between the two hemispheres 10, and likewise heat-contoured to the sphere's surface with a hot-air blower or through a hot-air tunnel—as is industrially common—with an operating air temperature considerably below the ignition temperature of the fuse cords of the assembly. At this point, the basic assembly of the device is complete.

Minor refinements to this procedure can include the addition of modest amounts of a silicone-based or other sealer compatible with the composition of the casing and the shrink-wrap film, to make the casing seams, filler plug and fuse cord holes impervious to intrusion of moisture, over and above the protection afforded by the shrink-wrap film. This assembly process is simple and rapid enough that, given pre-molded casings, a workforce of ten unskilled workers, or less, is able to assemble hundreds of units per day by hand, making production of the present invention accessible to even quite remote and underdeveloped areas.

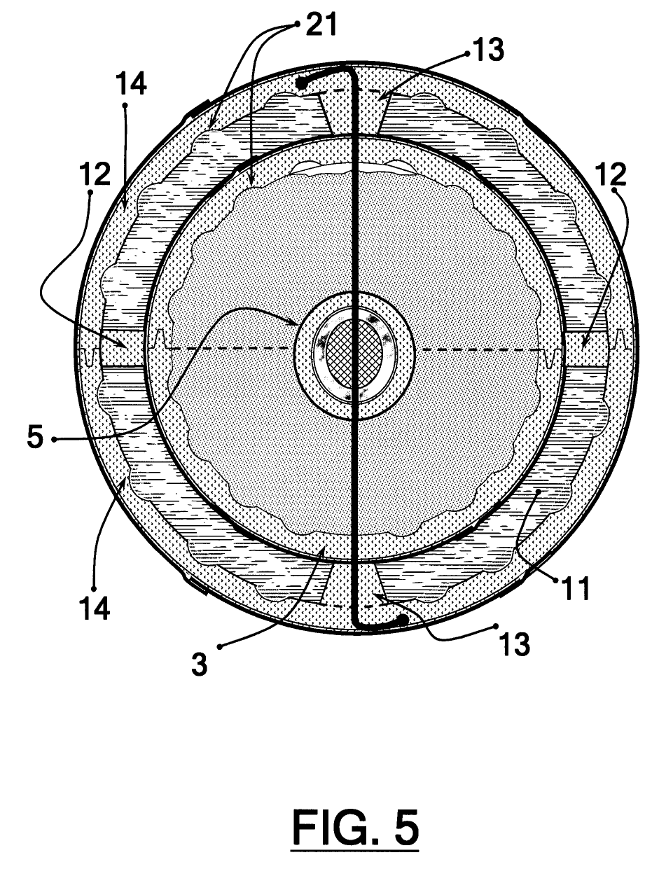

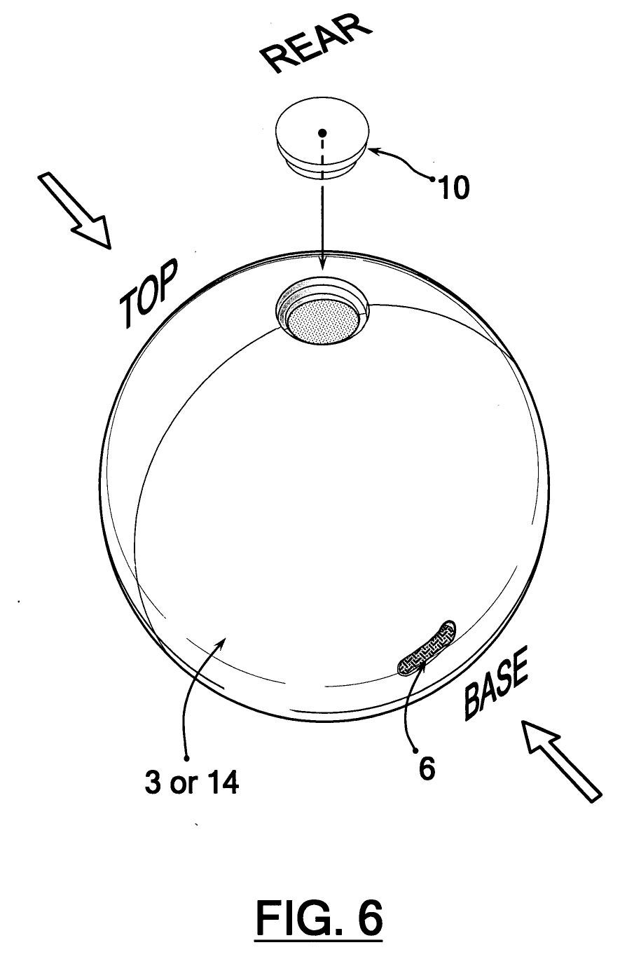

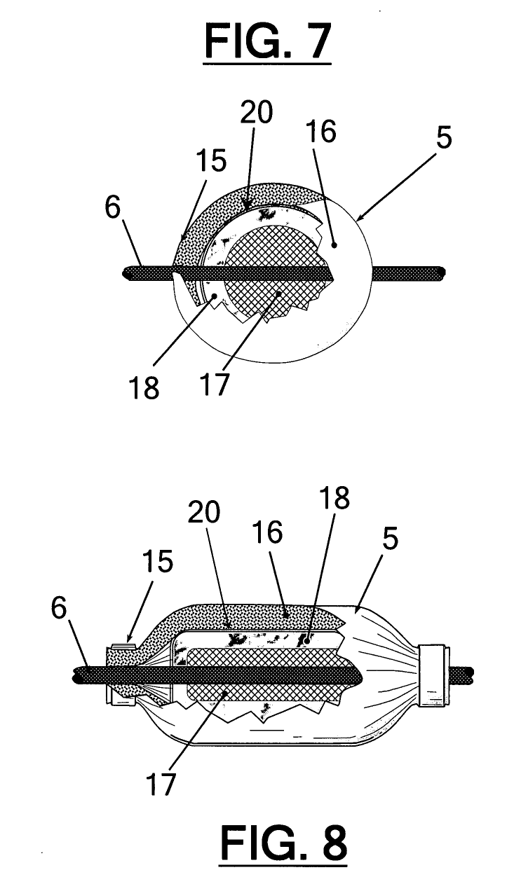

A modification, seen in FIG. 5 of the drawings supplied in this disclosure, is to encase the entire assembly described above within yet another, generally concentric shell 14, much like the first casing, but large enough to enclose a cavity between inner and outer casings, wherein that cavity can be filled with a second fire-extinguishing agent 11, likely dry or liquid, the nature of which could be as a reactant with the dry chemical charge of the inner core, or a second chemical agent to broaden the range of the device against various specialized types of fires, or even the addition of a liquid coolant—even plain water—to increase the fire suppressing efficiency of the device. The use of such coolants is effective due to the sudden expansion of the liquid into fine vapor, thus creating a cooling effect, which is known from many examples of prior art to have a marked effect on many types of fires.

Such ‘multi-walled’ construction as seen in FIG. 5 is not limited to a second outer casing in the intent of this disclosure. This disclosure contends that in this utility, the number of additional layers, and therefore chambers, that can be enclosed by yet another casing for separation of fire-extinguishing components is only limited to the practical value of the additional complexity of the additional layers. The advancement in the state-of-the-art here is the option of such fire-fighting sophistication and versatility available in a small and simple device that can be assembled at very rudimentary production facilities.

It should also here be stated that, because of the compactness and low cost of manufacture of the present invention, such devices could conveniently be located at numerous points within buildings, including in the corridors, lavatories and even closets of schools, offices and homes, providing therein a reliable and redundant protection against fires.

With a fixed installation of simple bracket holders on walls or near fire hazards, the desirable redundancy in self-actuating operation enhances the device's ability to provide protection by virtue of the pyrotechnic fuse and detonator, which permits the device to function spontaneously while placed statically on or in a bracket or holder without need of user intervention. Additionally, there is another inherent safety factor in the moderately loud audible burst upon detonation, which, if the device is self-actuated, suffices as a warning alarm, independent of other sensing devices or centralized systems using electronic circuitry.

The intuitively simple method of manual use requires less dexterity or forethought under tense, stressful conditions, increasing the likelihood of proper and effective use by unpracticed users. In cases where the blaze has advanced to the point of fuel sources and/or other fixtures having absorbed sufficient heat to smolder and re-ignite fires after initial flame suppression by any type of fire-extinguishing equipment, a small quantity of these devices are portable enough that they may be employed to help clear a path of exit out of an fire engulfed structure. As a ‘disposable’, single use device, when manual deployment is elected, projecting the device into a blaze is procedurally quicker, more basic and natural than the releasing of safety locks, setting of timers, opening valves or switches, operating triggers and/or directing of sprayed suppressants into the variable areas to fight the blaze, as in some prior art of one form or another. While those systems are not overly complex, it is widely known that victims of fires, even partially incapacitated by heat and/or smoke, and aware that they are in a life-threatening situation, may have difficulty with even simple tasks, wherein their mental faculties may thus be impaired.

1-27. (canceled)

28. A system comprising:
a container including an internal surface having dimpled, striated or other geometric patterns, indentations, or depressions;
a fire extinguishing material located within the container; and
an explosive device located within the container.

29. The system of claim 28, wherein the container comprises:
a plurality of casings, each respectively successively smaller one of the plurality of casings being located inside a respectively successively larger one of the plurality of casings.

30. The system of claim 29, further comprising at least one additional fire extinguishing material.

31. The system of claim 28, wherein the patterns, indentations, or depressions are molded-in.

32. The system of claim 28, wherein the explosive device is surrounded by a noise-suppressing device.

33. The system of claim 32, wherein the noise-suppressing device comprises first and second layers of noise-suppressing materials.

34. The system of claim 33, wherein the noise-suppressing device further comprises an intermediate layer, between the first and second layers, of plastic sheet wrap film.

35. The system of claim 33, wherein the first layer includes soft synthetic or natural sponge foam rubber material.

36. The system of claim 33, wherein the second layer includes cotton gauze wadding.

37. An apparatus comprising:
a container;
a fire extinguishing material located in the container; and
an explosive device located in a noise-suppressing device and in the container.

38. The system of claim 37, wherein the noise-suppressing device is spherical.

39. The system of claim 37, wherein the container comprises:
a plurality of casings, each respectively successively smaller one of the plurality of casings being located inside a respectively successively larger one of the plurality of casings.

40. The system of claim 37, wherein the noise-suppressing device comprises first and second layers of noise-suppressing materials.

41. The system of claim 37, wherein the noise-suppressing device further comprises an intermediate layer, between the first and second layers, of plastic sheet wrap film.

42. The system of claim 37, wherein the container includes an internal surface having dimpled, striated or other geometric patterns, indentations, or depressions configured to allow for even fragmentation of the container upon explosion of the explosive device.
